(19) United States
(12) Patent Application Publication
(10) Pub. No.: US 2024/0342941 A1
(43) Pub. Date: Oct. 17, 2024

(54) Foot Operated Slicing Tool

(71) Applicant: Rick Senger, Northfield, OH (US)

(72) Inventor: Rick Senger, Northfield, OH (US)

(21) Appl. No.: 18/628,872

(22) Filed: Apr. 8, 2024

Related U.S. Application Data
(60) Provisional application No. 63/495,327, filed on Apr. 11, 2023.

(51) Int. Cl. B26D 1/08; B26D 5/10

(52) U.S. Cl. CPC B26D 1/085; B26D 5/10

(57) ABSTRACT

A foot operated slicing tool for laminates, tiles, floor materials, vinyl, and more is disclosed. The tool is portable and does not require use of hands and shoulders for the operation thereof. In one embodiment, the lever of the tool is operatively connected to a blade unit and a foot pedal of the lever receives force from a leg and foot of a user to actuate the blade unit to slice a material. A lever arm and associated foot pedal is accessible along an edge of a platform for operating the tool and for applying a force to actuate the blade unit. The lever includes two pivotally connected arms, wherein upon application of force on the foot pedal, the lever moves an upper blade of the blade unit towards the lower blade to slice the material disposed therebetween.

### CROSS-REFERENCE TO RELATED APPLICATION

The present application claims priority to, and the benefit of, U.S. Provisional Application No. 63/495,327, which was filed on Apr. 11, 2023 and is incorporated herein by reference in its entirety.

### FIELD OF THE INVENTION

The present invention generally relates to the field of laminates and tile cutting devices. More specifically, the present invention relates to a novel multipurpose cutting device operated via a foot pedal for slicing vinyl, floor laminate, tile, wood flooring, and more. The device utilizes a foot pedal cutting mechanism and comes in two versions of the device with a foot pedal placed at the side or underneath a platform of the device. When force is applied using a foot, the lever of the device is activated to operate the blades for slicing a material. The device helps in conserving energy of an operator and requires significantly less physical strength to cut through thicker materials. Accordingly, the present disclosure makes specific reference thereto. Nonetheless, it is to be appreciated that aspects of the present invention are also equally applicable to other like applications, devices, and methods of manufacture.

### BACKGROUND

By way of background, materials such as tiles, floor laminates, and more are used in buildings, wood flooring, and renovation. Such materials require precise cuts in various sizes and shapes for use in different positions and orientations. Commonly, operators use hand press blades for cutting through the materials to give them different shapes and sizes. However, conventional hand press blades require significant physical strength to operate and cut through the materials. A lot of arm and shoulder strength is required for pushing the handle of such a blade and repetitive use can cause fatigue and strain in arms, shoulders, and back. Often, a user has to bend to slice a vinyl, tile, or laminate when a hand press blade is placed on a floor. Also, the position of conventional devices is not adjustable which may obstruct the application of full force. Further, hand press blades are generally used for smaller sizes of laminates and vinyl. This increases the time in cutting and slicing large laminates due to repetitive effort.

Handles of conventional hand press blade devices are relatively shorter, thereby providing less leverage to a user and thus requiring more force from the user to cut through the material. Long handles can destabilize such devices which reduces the cutting and slicing efficiency of the device and user.

Human legs are significantly stronger than arms and can push about four times the weight arms can handle. However current blade devices for cutting building materials are not designed to enable users to use legs to apply pressure. It would be desired to use legs to apply pressure to cut through laminates, vinyl, tiles, and more. Accordingly, individuals desire an improved flooring laminate cutting tool that is foot-operated for an efficient method of cutting building materials such as tiles, laminates, and vinyl.

Therefore, there exists a long felt need in the art for an improved multipurpose cutting device for slicing and cutting vinyl, floor laminate, tile, wood flooring, and more. There is also a long felt need in the art for a foot operated flooring cutting device. Additionally, there is a long felt need in the art for a novel device that replaces the existing hand press blade devices for cutting vinyl, floor laminate, tile, wood flooring, and more. Moreover, there is a long felt need in the art for a novel multipurpose cutting device that includes a foot pedal to receive pressure from a leg of a user to slice and cut a building material. Furthermore, there is a long felt need in the art for a multipurpose cutting device that can be adjusted to place the foot pedal at a comfortable height for applying pressure. Also, there is a long felt need in the art for a flooring cutting device that provides a long and pivoting handle for more leverage to a user. Finally, there is a long felt need in the art for a specially designed flooring cutting device that conserves energy, and relieves stress placed on the arms and hands of an operator while cutting through thick materials.

The subject matter disclosed and claimed herein, in one embodiment thereof, comprises a foot-operated cutting tool for laminate, tile, and flooring materials. The tool further comprises a platform for supporting materials to be cut, a cutting blade unit positioned at one end of the platform, including an upper blade and a lower blade, and a lever mechanism attached to a moving member of the tool which is positioned above the blade unit. The lever mechanism includes a foot pedal for actuating the cutting blade unit, wherein the lever mechanism facilitates movement of the upper blade towards the lower blade to perform a cutting operation, the lever can be operated by a foot of a user. The lever is positioned along one side of the platform and can be pivotally moved to slice a tile, laminate, or any other similar material. In another embodiment, the lever is designed for the foot pedal to be accessed below the platform of the tool.

In this manner, the foot-operated cutting tool of the present invention accomplishes all of the forgoing objectives and provides users with a multipurpose cutting device operated via a foot pedal for slicing vinyl, floor laminate, tile, wood flooring, and more. The tool features a foot pedal for applying pressure through the foot of a user for slicing material, thereby obviating use of hand and shoulder. The device helps in conserving energy and requires significantly less physical strength to cut through thicker materials. The long arm of the lever provides leverage, thus requiring less strength and force to slice materials.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a foot-operated cutting tool for laminate, tile, and flooring materials. The tool further comprises a platform for supporting materials to be cut, a cutting blade unit positioned at an end of the platform, including an upper blade and a lower blade, and a lever mechanism attached to a moving member of the tool which is positioned at one end of the platform, the lever mechanism including a foot pedal for actuating the cutting blade unit, wherein the lever mechanism facilitates movement of the upper blade towards the lower blade to perform a cutting operation, the lever can be operated by a foot of a user.

In another aspect, foot-operated slicing tool for tiles, laminates, and flooring materials is disclosed. The tool includes a platform that includes telescopic legs for height adjustment, each leg features telescopic buttons for independent length/height adjustment. A lever unit including pivotally connected a first member and a second member, wherein the lever unit includes a foot pedal at the end of the second member for receiving a foot of a user for actuating the lever to actuate a blade unit for slicing a laminate.

In another embodiment, the lever unit includes a first member and a second member, wherein the first member is connected to a moving member and associated housing. The second member has a foot pedal disposed at one end thereof, wherein when a user places a foot on the foot pedal and applies a force, the moving member and the associated housing is downwardly pushed to move an upper blade towards a lower blade to slice a material disposed between the upper blade and the lower blade.

In yet another embodiment, a building material slicing tool is disclosed. The tool includes a foot operated lever operatively connected to a blade unit, the lever includes two members positioned perpendicular to each other, wherein the two members are pivotally connected and operate a blade unit when a force is applied using a foot on a foot pedal disposed on an end of one of the two members.

In a further embodiment, the lever is integrated into the rear surface of the housing of the tool. The lever has a first arm extending vertically downward from the rear surface to a position below the platform and a second arm extends through and under the platform with a foot pedal on the opposite end, positioned in front of the front end of the tool. The lever provides enhanced leverage through an extended length of the horizontal second arm, facilitating casier and more efficient cutting of materials by vertical downward movement of the housing towards the platform.

In yet another aspect of the present invention, the tool includes a first button disposed on the housing for locking and unlocking the movement of the lever mechanism. A second button is included for adjusting the length of a component of the lever mechanism to accommodate users of different heights, enhancing the ergonomic utility of the tool.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the foot operated guillotine laminate cutter tool of the present invention in accordance with the disclosed architecture;

FIG. 2 illustrates a rear perspective view of the foot operated guillotine laminate cutter tool of FIG. 1 in accordance with the disclosed architecture;

FIG. 3 illustrates a perspective view showing use of the foot operated laminate slicing tool of FIG. 1 for slicing a laminate or tile in accordance with one embodiment of the present invention;

FIG. 4 illustrates a perspective view showing another embodiment of the foot operated guillotine laminate cutter tool of the present invention in accordance with the disclosed architecture; and

FIG. 5 illustrates a rear perspective view of the foot operated guillotine laminate cutter tool of FIG. 4 in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved multipurpose cutting device for slicing and cutting vinyl, floor laminate, tile, wood flooring, and more. There is also a long felt need in the art for a foot operated flooring cutting device. Additionally, there is a long felt need in the art for a novel device that replaces the existing hand press blade devices for cutting vinyl, floor laminate, tile, wood flooring, and more. Moreover, there is a long felt need in the art for a novel multipurpose cutting device that includes a foot pedal to receive pressure from a leg of a user to slice and cut a building material. Furthermore, there is a long felt need in the art for a multipurpose cutting device that can be adjusted to place the foot pedal at a comfortable height for applying pressure. Also, there is a long felt need in the art for a flooring cutting device that provides a long and pivoting handle for more leverage to a user. Finally, there is a long felt need in the art for a specially designed flooring cutting device that conserves energy, and relieves stress placed on the arms and hands of an operator while cutting through thick materials.

The present invention, in one exemplary embodiment, is a foot-operated slicing tool for tiles, laminates, and flooring materials. The tool includes a platform that includes telescopic legs for height adjustment, each leg features telescopic buttons for independent length adjustment. A lever unit pivotally connected to a first member and a second member, wherein the lever unit includes a foot pedal at the end of the second member for receiving a foot of a user for actuating the lever to actuate a blade unit for slicing a laminate. The foot pedal can be accessed along a side of the platform or below the platform to meet requirements of different users.

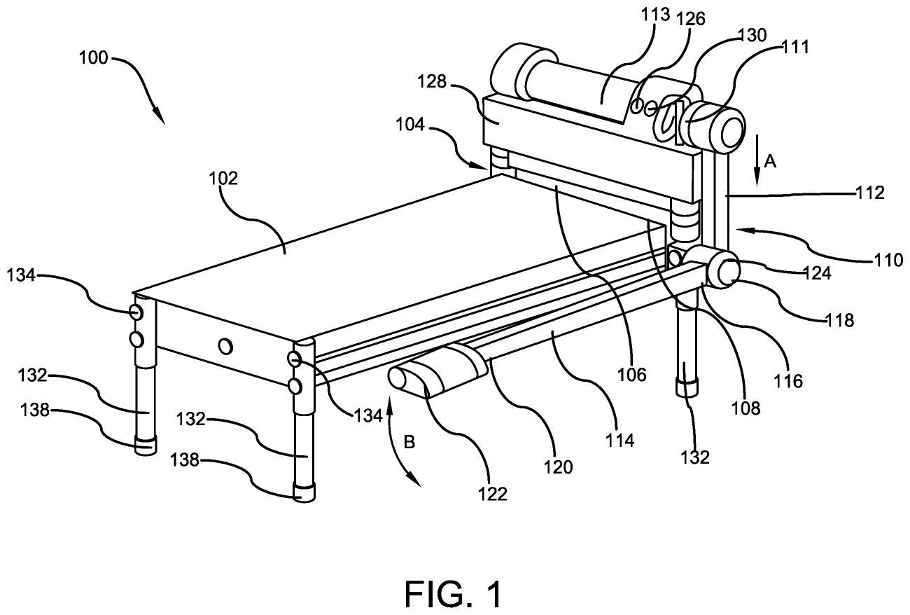

Referring initially to the drawings, FIG. 1 illustrates a perspective view of one potential embodiment of the foot operated guillotine laminate cutter tool of the present invention in accordance with the disclosed architecture. The foot operated guillotine laminate cutter tool 100 of the present invention is designed for cutting floor materials such as laminate, vinyl, wood flooring, and siding. The tool can be used either on a tabletop or directly on the floor, depending on the specific needs of the project or the preference of the user. More specifically, the laminate slicing tool 100 includes a platform 102 for providing a stable surface for placing the laminate planks, tiles, wooden floor sheets, and more during cutting. The platform 102 can be made of any non-slippery material and can be designed in different sizes and shapes.

A cutting blade unit 104 is included in the tool 100 and is used for slicing laminates, flooring, and more. The cutting blade 104 is preferably made of hardened steel or carbide for providing sharpness and durability. The cutting blade 104 is preferably a guillotine-style blade and includes an upper blade 106 and a lower blade 108 at the end of the platform 102 and coplanar with the platform 102 wherein a laminate/tile/sheet/plank to be sliced is positioned between the upper blade 106 and the lower blade 108.

A lever 110 is attached to one end 111 of the moving member 113 of the foot operated laminate slicing tool 100. The lever 110 includes a first member 112 disposed transversal to the platform 102 as illustrated in the direction of Arrow A. A second member 114 of the lever 110 has a first end 116 connected to the hinged bottom end 118 of the first member 112. The opposite second end 120 of the second member 114 has an ergonomic foot pedal 122 attached thereto. The second member 114 extends perpendicular to the first member 112 and is adapted to pivot relative to the first member 112 along the hinged member 124. The second member 114 can pivot in the direction shown by the arrow B.

The foot pedal 122 enables a user to put a foot thereon and to push the second member 114 downwards to push the lever 110, thereby vertically downwardly moving the moving member 114 and housing 128 to push the upper blade 106 towards the lower blade 108. Any laminate, tile, flooring, or more placed between the upper blade 106 and the lower blade 108 is sliced without applying force using hand and shoulder by a user. The foot operated laminate slicing tool 100 transfers the effort of cutting and slicing laminates from the arms and hands to the legs and feet, thereby significantly reducing the stress and potential strain on the upper body. The side cutter laminate slicing tool 100 is especially useful for users who operate the tool for extended periods or have existing issues with hand or arm strength.

A first button 126 is disposed on the housing 128 of the moving member 113 and is adapted to lock and unlock the movement of the lever 110. A second button 130 enables a user to adjust a length of the first member 112 of the lever 110, thereby adjusting the lever 110 for operation by individuals of different heights. The moving member 113 spins to enable the lever 110 to move radially and to turn along the end 111 of the moving member 113.

In the preferred embodiment, the tool 100 has dimensions of 20 to 30 inches long, 12 to 24 inches wide, and 10 to 18 inches high. The height of the tool 100 enables a user to easily operate and move the foot pedal 122 for slicing laminates and floorings. The platform 102 can have telescopic legs 132 for adjusting a height of the tool 100 for operation by different users. Each leg has corresponding telescopic buttons 134 for adjusting length of the leg independently. The long length of the second member 114 enables users to provide an effective force to slice a laminate.

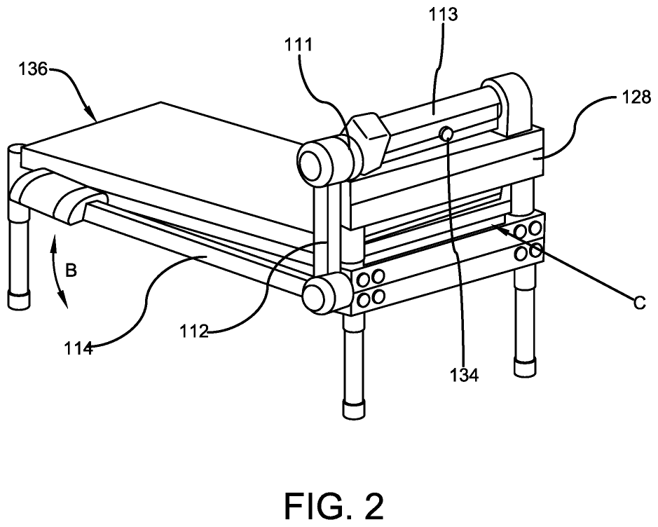

FIG. 2 illustrates a rear perspective view of the foot operated guillotine laminate cutter tool of FIG. 1 in accordance with the disclosed architecture. The first member 112 of the lever 110 is attached to the moving member 113 at the one end 111, wherein the snap button 134 disposed on the moving member 113 enables to remove the moving member 113 and the lever 110 from the housing 128. Each leg 132 can have anti-slip element 138 such as rubber elements disposed at the bottom end of the corresponding leg.

Preferably, a laminate, a tile, or a panel is inserted between the blades 106, 108 from the rear side (Arrow C) for slicing. Alternatively, the laminate, tile, or panel can be placed on the platform 102 and can be pushed between the blades 106, 108. In some embodiments, the platform 102 can be sliding along a belt towards the direction from the front end 136 of the platform 102 towards the rear side of the tool 100, thereby automatically sliding a laminate for slicing.

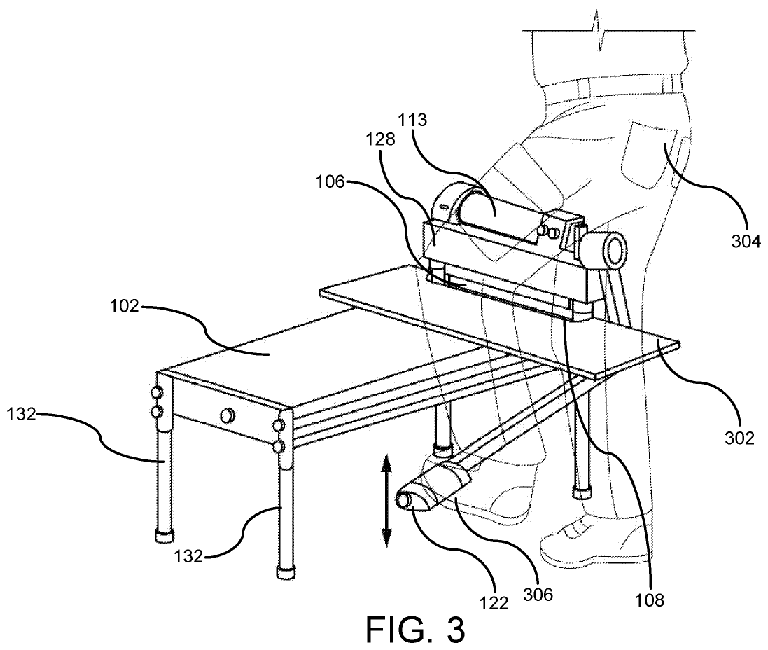

FIG. 3 illustrates a perspective view showing use of the foot operated laminate slicing tool of FIG. 1 for slicing a laminate in accordance with one embodiment of the present invention. As illustrated, a laminate 302 is slid between the blades 106, 108 and any desired size of the laminate can be inserted for slicing. For slicing the laminate 302, a user 304 places a foot 306 on the foot pedal 122 and pushes towards the floor to actuate the lever 110 to push the moving member 113 and housing 128 vertically downwardly. The movement pushes the upper blade 106 to slice the laminate 302 without using hands, arms, or shoulders. The legs 132 can be adjusted in height enabling the tool 100 to be used by individuals of different heights. During slicing, the laminate 302 is supported by the platform 102 for preventing any unintentional movement of the laminate 302.

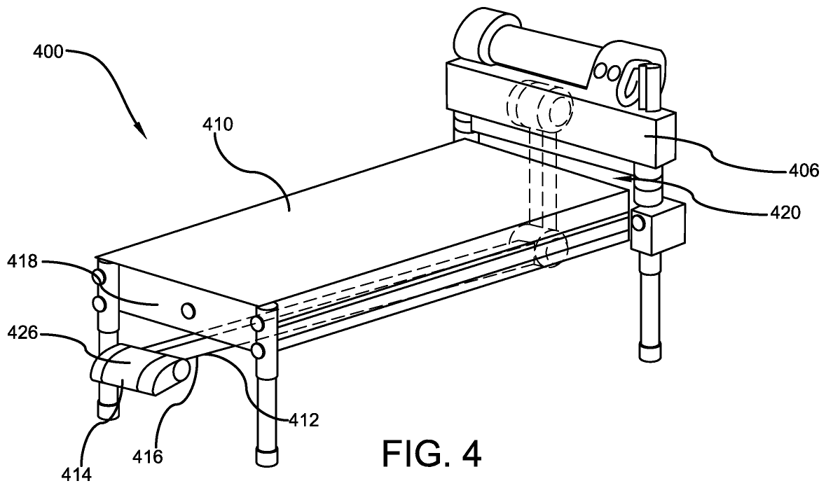

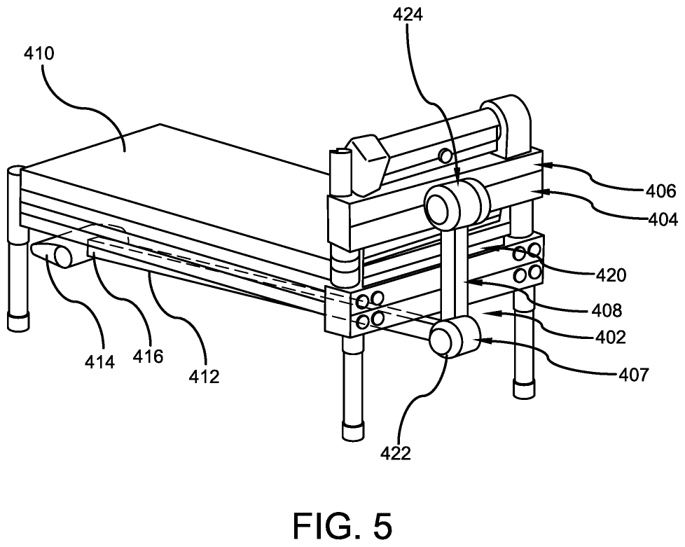

FIG. 4 illustrates a perspective view showing another embodiment of the foot operated guillotine laminate cutter tool of the present invention in accordance with the disclosed architecture. Referring now to FIGS. 4 and 5, in the present embodiment, the lever 402 of the undercutter tool 400 is integrated to the rear surface 404 of the housing 406. The first arm 408 of the lever 402 extends vertically downwardly from the rear surface 404 of the housing 406 to a second end 407 positioned below the platform 410. The second arm 412 of the lever 402 extends through and under the platform 410 with the foot pedal 414 disposed on the opposite end 416 of the second arm 412. The foot pedal 414 is positioned in front of the front end 418 of the tool 400, thereby enabling a user to push the foot pedal 414 down, thereby pushing the housing 406 vertically downwardly towards the platform 410 to slice a laminate using the cutting blade 420.

The tool 400 provides an enhanced leverage for the lever 402 by providing an extended length of the horizontal second arm 412. The first hinge 422 enables a pivotal movement of the second arm 412 relative to the first arm 408. The second hinge 424 can enable a pivotal movement of the first arm 408 relative to the housing 406.

In different embodiments of the present invention, the foot pedal can slide across the corresponding second arm of the lever. Further, the lever can include a foot slot 426 for accommodating a foot of a user for pushing the lever.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “foot operated guillotine laminate cutter tool”, “foot operated laminate slicing tool”, “laminate slicing tool”, “undercutter tool”, “side cutter laminate slicing tool”, and “tool” are interchangeable and refer to the foot operated guillotine laminate cutter tool 100, 400 of the present invention.

Notwithstanding the forgoing, the foot operated guillotine laminate cutter tool 100, 400 of the present invention can be of any suitable size and configuration as is known in the art without affecting the overall concept of the invention, provided that it accomplishes the above stated objectives. One of ordinary skill in the art will appreciate that the foot operated guillotine laminate cutter tool 100, 400 as shown in the FIGS. are for illustrative purposes only, and that many other sizes and shapes of the foot operated guillotine laminate cutter tool 100, 400 are well within the scope of the present disclosure. Although the dimensions of the foot operated guillotine laminate cutter tool 100, 400 are important design parameters for user convenience, the foot operated guillotine laminate cutter tool 100, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A laminate slicing tool comprising:
a platform,
a cutting tool, and
a lever;
wherein said platform having a planar surface for placing a laminate thereon;
wherein said cutting tool having a guillotine blade including an upper blade and a lower blade coplanar with said platform for placing the laminate therebetween;
wherein said cutting tool having said lever attached to one end of a moving member of said platform;
wherein said lever having a first member transversal to said platform and a second member aligned to said platform;
wherein said second member having a foot pedal for actuating said lever; and
further wherein actuation of said foot pedal pushes said upper blade towards said lower blade for cutting the laminate therebetween.

2. The laminate slicing tool of claim 1, wherein said second member of said lever having a first end connected to a hinged bottom end of said first member.

3. The laminate slicing tool of claim 2, wherein said second member of said lever having a second end connected to said foot pedal.

4. The laminate slicing tool of claim 3, wherein said second member extends perpendicular to said first member and pivots relative to said first member along said hinged bottom end.

5. The laminate slicing tool of claim 4, wherein said foot pedal actuated by the foot of a user to push said second member downwards.

6. The laminate slicing tool of claim 5, wherein said laminate is selected from the group consisting of a plank, a tile, a wooden floor sheet, and a laminate sheet.

7. The laminate slicing tool of claim 6, wherein said guillotine blade having a material selected from the group consisting of a hardened steel and a carbide.

8. A laminate slicing tool comprising:
a platform,
a cutting tool, and
a lever;
wherein said platform having a planar surface for placing a laminate thereon and a plurality of telescoping legs for adjusting a height of said platform;
wherein said cutting tool having a guillotine blade including an upper blade and a lower blade coplanar with said platform for placing the laminate therebetween;
wherein said cutting tool having said lever attached to one end of a moving member of said platform;
wherein said lever having a first member transversal to said platform and a second member aligned to said platform;
wherein said first member having an adjustable height for operation of said cutting tool by individuals of different heights;
wherein said second member having a foot pedal for actuating said lever; and
further wherein actuation of said foot pedal pushes said upper blade towards said lower blade for cutting the laminate therebetween.

9. The laminate slicing tool of claim 8, wherein said second member of said lever having a first end connected to a hinged bottom end of said first member.

10. The laminate slicing tool of claim 9, wherein said second member of said lever having a second end connected to said foot pedal.

11. The laminate slicing tool of claim 10, wherein said second member extends perpendicular to said first member and pivots relative to said first member along said hinged bottom end.

12. The laminate slicing tool of claim 8, wherein said foot pedal actuated by the foot of a user to push said second member downwards.

13. The laminate slicing tool of claim 8, wherein said laminate is selected from the group consisting of a plank, a tile, a wooden floor sheet, and a laminate sheet.

14. The laminate slicing tool of claim 8, wherein said guillotine blade having a material selected from the group consisting of a hardened steel and a carbide.

15. A laminate slicing tool comprising:
a platform,
a cutting tool, and
a lever;
wherein said platform having a planar surface for placing a laminate thereon and a plurality of telescoping legs for adjusting a height of said platform;
wherein said cutting tool having a guillotine blade including an upper blade and a lower blade coplanar with said platform for placing the laminate therebetween;
wherein said cutting tool having said lever attached to one end of a moving member of said platform;
wherein said lever having a first member transversal to said platform and a second member aligned to said platform;
wherein said first member having a first length and said second member having a second length;
wherein said second length is greater than said first length;
wherein said second member having a foot pedal for actuating said lever; and
further wherein actuation of said foot pedal pushes said upper blade towards said lower blade for cutting the laminate therebetween.

16. The laminate slicing tool of claim 15, wherein said second member of said lever having a first end connected to a hinged bottom end of said first member.

17. The laminate slicing tool of claim 16, wherein said second member of said lever having a second end connected to said foot pedal.

18. The laminate slicing tool of claim 17, wherein said second member extends perpendicular to said first member and pivots relative to said first member along said hinged bottom end.

19. The laminate slicing tool of claim 18, wherein said foot pedal actuated by the foot of a user to push said second member downwards.

20. The laminate slicing tool of claim 19, wherein said laminate is selected from the group consisting of a plank, a tile, a wooden floor sheet, and a laminate sheet.
